(19) United States
(12) Patent Application Publication
(10) Pub. No.: US 2005/0147957 A1
(43) Pub. Date: Jul. 7, 2005

(54) Combination themed memorabilia storage and photo display device

(76) Inventor: Charles Whitlow, Cusseta, AL (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/752,807

(22) Filed: Jan. 7, 2004

(51) Int. Cl. G09B 25/00

(52) U.S. Cl. 434/428

(57) ABSTRACT

A device for displaying a selected grouping of photographs within a three-dimensional structure, wherein an internal compartment enables storage of memorabilia, and wherein the structure is themedly related to the content thereof.

### TECHNICAL FIELD

The present invention relates generally to photograph displays and, more specifically, to a device for displaying a selected grouping of photographs within a three-dimensional structure, wherein an internal compartment enables storage of memorabilia, and wherein the structure is themedly related to the content thereof. The present invention is particularly useful as, although not strictly limited to, a schoolhouse structure, wherein windows enable the framed sequential display of traditional annual school portraits, and wherein the roof opens to provide access to an interior compartment for receiving report cards, awards, and the like.

### BACKGROUND OF THE INVENTION

Most individuals enjoy keeping albums of photographs to recall and reminisce about particularly enjoyable events, such as vacations. Further, many such individuals gather memorabilia for the same purpose. For example, some collect a matchbook at each restaurant they enjoy. Others save ticket stubs and programs from the theatre or concerts. Unfortunately, organization of such photos and souvenirs into a scrapbook can be very time intensive. Additionally, many types of collectable memorabilia are not suitable for placement into a book-type format. As a result, most households likely contain boxes, bags or otherwise unsorted accumulations of vacation and event artifacts.

In addition, parents are faced with the undaunting task of collecting and preserving a record of the childhood achievements and special memories of their children in order to afford them the opportunity to look back on their youth as they grow older. Even young children enjoy looking at photographs of themselves as babies, often studying each with great interest and asking questions regarding the specifics of the moment that the photo was taken. With all of this in mind, most schools continue to provide an opportunity for each child to obtain an annual portrait and thereby create an essentially permanent record of his or her appearance each year during the progression from kindergarten to high school graduation.

Parents also save schoolwork samples, report cards, art work, and other notable school-related artifacts, such as programs for school plays, and perhaps even videotapes of such events. Most depend upon cardboard boxes or plastic storage bins for the preservation of this irreplaceable material. Cardboard boxes are disadvantageous because they are especially susceptible to degradation and fail to provide reliable protection for their contents. Although plastic storage bins are more durable, they can disadvantageously encourage mildew damage to contents in humid or extreme temperature storage conditions, such as in an attic, where such storage is common.

In addition to storing memorabilia, it is also desirable to create displays thereof, particularly with reference to photos. As such, frames have been designed, for instance, to receive and display an athlete's photograph and a team photograph together, wherein some such frames are two-dimensionally themedly related to the sport. One such example is a picture frame having a circular shape and coloration of a soccer ball for the display of a child's soccer photo. Another type of frame has been designed to enable the display of consecutive school photos, wherein the shape of the frame is two-dimensionally themed as a school bus, wherein the bus windows are adapted to retain photographs therein. Unfortunately, none of these frames provide any other benefit or serve any other purpose other than photo display.

Therefore, it is readily apparent that there is a need for a device for displaying a selected grouping of photographs within a three-dimensional structure, wherein an internal compartment enables storage of memorabilia therewithin, and wherein the structure is themedly related to the content thereof, thus preventing the above-discussed disadvantages.

### BRIEF SUMMARY OF THE INVENTION

Briefly described, in a preferred embodiment, the present invention overcomes the above-mentioned disadvantages and meets the recognized need for such a device by providing a schoolhouse structure, wherein windows enable the framed sequential display of traditional annual school portraits, and wherein the roof opens to provide access to an interior compartment for receiving report cards, awards, and the like.

According to its major aspects and broadly stated, the present invention is a device for displaying a selected grouping of photographs within a three-dimensional structure, wherein an internal compartment enables storage of memorabilia, and wherein the structure is themedly related to the content thereof.

More specifically, the present invention in its preferred form is a wooden storage container having a three-dimensional configuration reminiscent of an old fashioned schoolhouse, wherein the walls and floor of the schoolhouse define the base of the storage container and the roof of the schoolhouse defines the lid. The lid is preferably removable, wherein removal thereof enables access into the interior storage compartment for placement and/or removal of memorabilia, such as, for exemplary purposes only, report cards, awards, school records, yearbooks and the like, and wherein the interior storage compartment preferably has ornamentation therein to depict a school room, such as, for exemplary purposes only, a chalk board, ABC chart, and/or clock. Such ornamentation may be authentic, thereby enabling use of the present invention as a schoolhouse-style doll playhouse for young children. Additionally, photo frames are provided on the exterior of the storage container, in the design of schoolhouse windows, wherein the arrangement of the windows enables the sequential display of traditional annual school portraits, from primary school through high school.

A feature and advantage of the present invention is its ability to enable a user to quickly and easily add or change from one photographic display to another.

Another feature and advantage of the present invention is its ability to display a selected grouping of photographs and to concurrently store memorabilia.

Another feature and advantage of the present invention is its ability to display and store photographs, in addition to various other objects that are not suitable for placement in an album.

Another feature and advantage of the present invention is its ability to provide parents with an easily accessible means of preserving a record of their children's achievements.

Another feature and advantage of the present invention is its ability to be utilized as a play toy when not being utilized for memorabilia storage.

Yet another feature and advantage of the present invention is its ability to protect its contents from adverse environmental conditions.

Another feature and advantage of the present invention is its ability to provide a photo display in a themedly related three-dimensional frame, while also serving a utilitarian purpose.

Another feature and advantage of the present invention is its ability to utilize windows as frames, thereby creating the illusion that portrait subjects of a series of traditional annual school portraits are present within a schoolhouse building.

Another feature and advantage of the present invention is its ability to incorporate and display mascot depictions, emblems and notable school coloration to enhance visual display.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of a combination themed memorabilia storage and photo display device according to a preferred embodiment of the present invention.

FIG. 2 is a front, elevational view of the combination themed memorabilia storage and photo display device of FIG. 1.

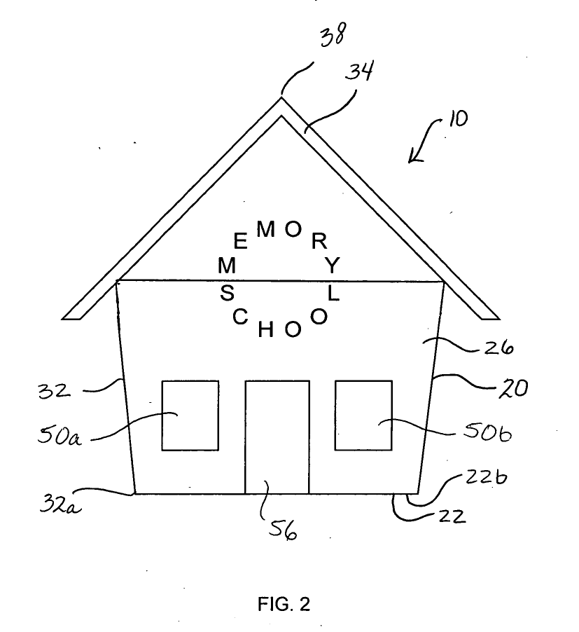

FIG. 3 is an overhead, perspective view of the combination themed memorabilia storage and photo display device of FIG. 1, showing the roof removed to enable interior access.

FIG. 4 is an overhead, perspective view of a combination themed memorabilia storage and photo display device according to an alternate embodiment of the present invention, showing the roof removed to enable interior access.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

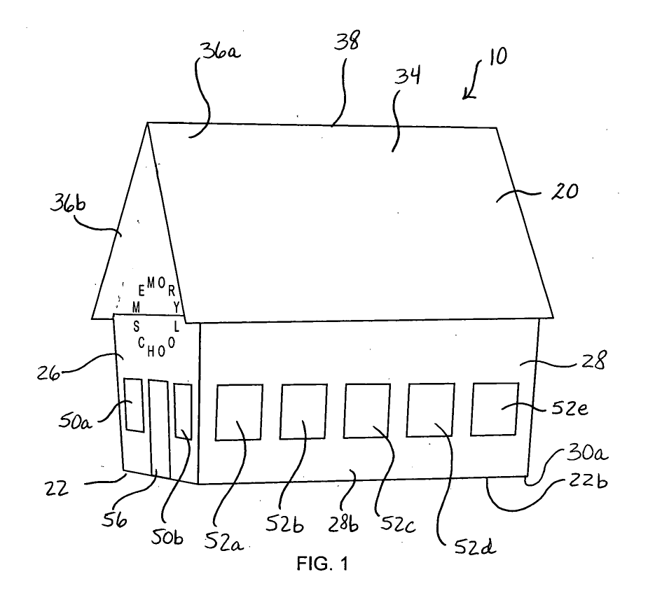

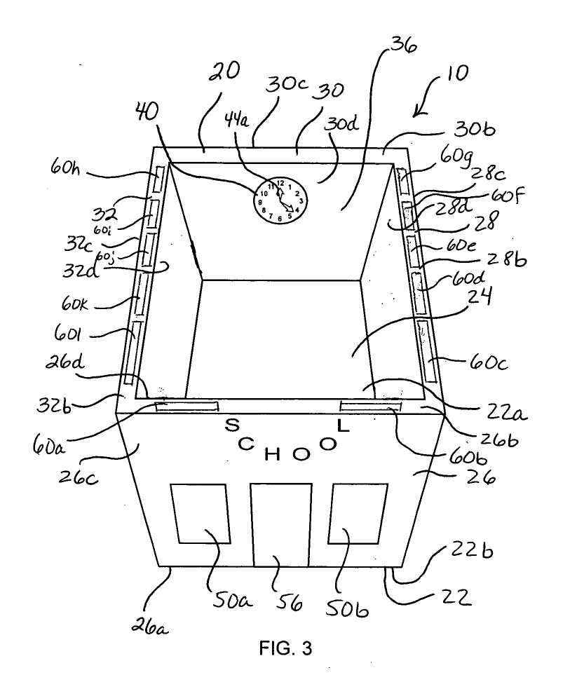

Referring now to FIGS. 1 and 3, the present invention in its preferred form is a combination storage container and photo display device 10 having a three-dimensional configuration preferably reminiscent of an old fashioned schoolhouse 20. While other configurations could be utilized and are anticipated within the scope of the invention herein described, the configuration of schoolhouse 20 is preferred for receiving and storing report cards and the like, and for displaying school portraits. Alternate three-dimensional configurations could include, for example, a domed stadium design for receiving and storing sports memorabilia and the like, and for displaying player photographs, or any other desirable configuration themedly related to the memorabilia stored therein and photos displayed thereby.

Preferably, combination storage container and photo display device 10 is wooden, thereby effectively re-creating the authentic architecture for preferred schoolhouse 20. It is recognized, however, that other suitable materials could be utilized such as, for exemplary purposes only, synthetic wood-like materials, plastic, metal, foam, or glass. Preferably, schoolhouse 20 has base 22 with upper surface 22a defining floor 24 for schoolhouse 20 and lower surface 22b providing support.

Preferably, schoolhouse 20 has front wall 26, first side wall 28, rear wall 30, and second side wall 32, wherein said walls 26, 28, 30 and 32 support roof 34 and define interior storage space 36. Front wall 26 has bottom edge 26a and top edge 26b; first side wall 28 has bottom edge 28a and top edge 28b; rear wall 30 has bottom edge 30a and top edge 30b; and second side wall 32 has bottom edge 32a and top edge 32b, wherein bottom edges 26a, 28a, 30a and 32a are preferably positioned proximate base 22. Front wall 26 has outer surface 26c and inner surface 26d; first side wall 28 has outer surface 28c and inner surface 28d; rear wall 30 has outer surface 30c and inner surface 30d; and second side wall 32 has outer surface 32c and inner surface 32d, wherein inner surfaces 26d, 28d, 30d and 32d preferably define a perimeter for interior storage space 36.

Roof 34 is preferably removable, thereby enabling access to interior storage space 36. One skilled in the art would readily recognize that roof 34 could alternately be hingedly related to first or second side walls 28 or 32, respectively, could be hingedly related to both first and second side walls 28 and 32, wherein first side 36a and second side 36b could open along peak 38 to permit access to interior storage space 36, or could be hinged or otherwise openable along any appropriate axis.

In the preferred three-dimensional configuration of schoolhouse 20, interior storage space 36 preferably includes relevant ornamentation. That is, inner surfaces 26d, 28d, 30d and/or 32d preferably depict a school room. Preferably, clock 40 and chalk board 42 (not shown) are provided in working form, to facilitate the enjoyable use of schoolhouse 20 as a toy or doll house when not being utilized for storage, wherein clock 40 preferably has movable hands 44a and chalk board 42 possesses a writeable surface. It is anticipated that other forms of ornamentation could be utilized within schoolhouse 20 such as, for exemplary purposes only, an ABC chart and/or magnetic, dry erase board. Further, in an alternate three-dimensional configuration, such as a domed stadium, ornamentation could depict a locker room and/or playing field.

Preferably, front wall 26 has two windows 50a and 50b defined therein; first side wall 28 has five windows 52a, 52b, 52c, 52d and 52e defined therein; and second side wall 32 has five windows 54a, 54b, 54c, 54d and 54e (54d and 54e not shown) defined therein, preferably resulting in a total of twelve windows. Each window 50a-50b, 52a-52e, and 54a-54e preferably functions as a picture frame that is dimensioned to receive and display a photograph. A total of twelve windows is preferred to enable the placement and display of twelve pictures, preferably one corresponding to each school year, first grade through twelfth grade. Although twelve is the preferred number of windows, any appropriate number could be alternately utilized. For example, additional windows could be included in order to facilitate the inclusion and display of kindergarten and/or preschool photos.

Preferably, front wall 26 has door 56 defined therein. Alternately, a hinged door (not shown) could be provided to facilitate doll-house type play. Further, door 56 could be merely a graphic representation of a door.

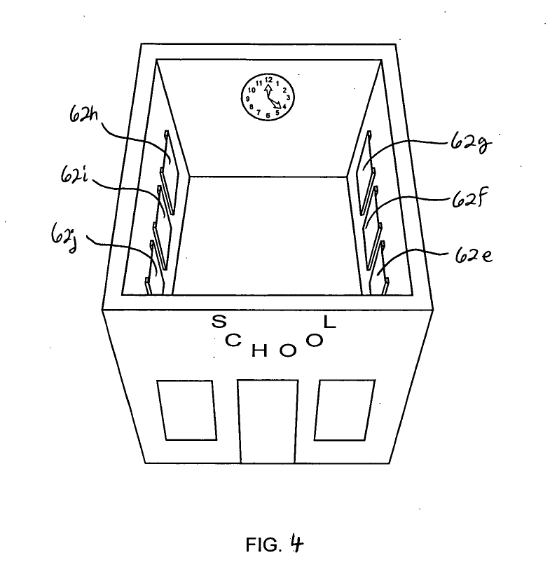

Preferably, accessways 60a and 60b are defined in top edge 26b of front wall 26; accessways 60c-60g are defined in top edge 28a of first side wall 28; and accessways 60h-60l are defined in top edge 32b of second side wall 32. Each preferred accessway 60a-60l is preferably relatedly positioned to each window 50a-50b, 52a-52e, and 54a-54e, respectively, to enable slidable insertion of a photograph into same, as best seen in FIG. 3. In an alternate configuration, as depicted in FIG. 4, front wall 26, first side wall 28 and second side wall 32 could be formed without accessways 60a-60l defined therein. Instead, photo support members 62a-62b (not shown) could be provided on inner surface 26d of front wall 26, photo support members 62c-62g (62c-62d not shown) could be provided on inner surface 28d of first side wall 28, and photo support members 62h-62l (62k-62l not shown) could be provided on inner surface 32d of second side wall 32.

In an alternate embodiment, windows 50a-50b, 52a-52e, and 54a-54e could have a transparent, protective covering, such as, for exemplary purposes only, plastic or glass.

In another alternate embodiment, interior storage space 36 could have known hanging file-type apparatus provided therein to enable organization of paper items stored within schoolhouse 20.

In another alternate embodiment, combination storage container and photo display device 10 could have a locking mechanism to facilitate security of items stored therein, or could include a suitable bracket or plate for receiving a user-supplied lock.

In another alternate embodiment, a storage drawer or plurality of drawers could be included to assist in organization of memorabilia within interior storage space 36.

In still another alternate embodiment, schoolhouse 20 could have lights, wherein photo display and/or other ornamental features could be illuminated via battery power and/or household current.

In use, roof 34 of preferred schoolhouse 20 is removed by a user and interior storage space 36 is thereby accessed. The user can place report cards or any other desired objects and/or memorabilia therein. Additionally, the user can insert a photo into a preferred accessway 60a-60l to position the photo for display via window 50a-50b, 52a-52e, and 54a-54e, respectively. Roof 34 is replaced and schoolhouse 20 can be displayed, with memorabilia stored therein and photo(s) visible thereon.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A themed combination storage and display device, comprising:
an openable container defined by a plurality of peripheral walls, a base and a top, said plurality of peripheral walls and said base defining an interior compartment, and
a plurality of display frames, said plurality of display frames defined in said plurality of peripheral walls,
wherein said container has a three-dimensional configuration themedly related to the stored contents.

2. The themed combination storage and display device of claim 1, wherein said top is removable.

3. The themed combination storage and display device of claim 1, wherein said top is hingedly related to at least one of said plurality of peripheral walls.

4. The themed combination storage and display device of claim 1, wherein said three-dimensional configuration is in the form of a school building.

5. The themed combination storage and display device of claim 4, wherein said plurality of display frames is a plurality of windows of said school building.

6. The themed combination storage and display device of claim 4, wherein said top is a roof.

7. The themed combination storage and display device of claim 4, wherein said plurality of display frames is suitable for receipt and sequential display of annual school photographs.

8. The themed combination storage and display device of claim 1, wherein said interior storage compartment has ornamentation.

9. The themed combination storage and display device of claim 4, wherein said interior storage compartment has ornamentation, wherein said ornamentation is at least one school room component.

10. The themed combination storage and display device of claim 9, wherein said ornamentation is a chalkboard.

11. The themed combination storage and display device of claim 9, wherein said ornamentation is a clock.

12. The themed combination storage and display device of claim 4, wherein said school building carries a school mascot emblem.

13. The themed combination storage and display device of claim 4, wherein said school building depicts a school color scheme.

14. The themed combination storage and display device of claim 1, wherein said three-dimensional configuration is in the form of a sports arena.

15. The themed combination storage and display device of claim 5, further comprising a door.

16. The themed combination storage and display device of claim 5, wherein each said window of said plurality of windows carries an essentially transparent covering.

17. The themed combination storage and display device of claim 1, further comprising hanging file-type apparatus disposed within said interior compartment.

17. The themed combination storage and display device of claim 1, further comprising a locking mechanism.

18. A method of storing and displaying themed memorabilia, comprising the steps of:
(a) obtaining a themed storage and display device defined by a plurality of peripheral walls, a base and a top, said plurality of peripheral walls and said base defining an interior compartment, and a plurality of display frames, said plurality of display frames defined in said plurality of peripheral walls;
(b) opening said top of said themed storage and display device;
(c) placing the themed memorabilia into said interior compartment;
(d) inserting the photographic memorabilia into said plurality of display frames;
(e) replacing said top of said themed storage and display device.

19. The method of claim 18, wherein said themed storage and display device has a schoolhouse-shape, wherein said plurality of display frames is a plurality of windows, and wherein said top is a roof.
